(19) United States
(12) Patent Application Publication
(10) Pub. No.: US 2025/0339872 A1
(43) Pub. Date: Nov. 6, 2025

(54) SPRINKLER SYSTEM ARRANGEMENT

(71) Applicant: Matthew Douglas Hunsberger, Mishawaka, IN (US)

(72) Inventor: Matthew Douglas Hunsberger, Mishawaka, IN (US)

(21) Appl. No.: 19/264,451

(22) Filed: Jul. 9, 2025

Related U.S. Application Data
(63) Continuation of application No. 17/803,349, filed on May 25, 2022.

(51) Int. Cl. B05B 15/16; A62C 35/68

(52) U.S. Cl. CPC B05B 15/16; A62C 35/68

(57) ABSTRACT

A sprinkler head cage or cover limits or prevents inadvertent actuation of a sprinkler head without significant reduction in sprinkler head fire suppression capability, the cage or cover having an enlarged opening for receiving a variety of different sprinkler head sizes and/or configurations, with a slidably mounted yoke for engaging a sprinkler head, having a camming surface therein for directing alignment of the sprinkler head within the cage as the camming surface is moved along a portion of the sprinkler head. The yoke can provide a positive fit and/or location for the sprinkler head within the cage where the camming surface directs the yoke into engagement with opposing surfaces of the sprinkler head sufficient to restrict motion of the sprinkler head with respect to the cage.

### CROSS REFERENCE TO RELATED APPLICATION

The present application is a continuation of U.S. patent application Ser. No. 17/803,349 filed May 25, 2022, which is hereby incorporated herein by reference in its entirety.

### FIELD

The present disclosure relates generally to fire protection systems, and more particularly fire protection systems having one or more sprinkler heads attached to fluid supply pipes, such as those which may be actuated by heat and/or smoke to spray water or other fire retardant fluid within a building to extinguish or help combat a fire therein.

### BACKGROUND

Previously, a variety of such fire protection systems have been used, typically suspended near the building ceiling so as to spray water down onto a fire, via the sprinkler heads. Unfortunately, given the particular uses to which some buildings are put, those sprinkler heads may be inadvertently actuated by contact of foreign objects (basketballs, vehicles, machinery, or the like) with the sprinkler heads. It has been suggested that such inadvertent actuation can be minimized by surrounding or enclosing the sprinkler heads at least in part with a protective cage or cover, which does not significantly affect the distribution of water or fire retardant fluid as needed in response to a fire.

Unfortunately, however, not all sprinkler heads are of the same size or configuration or are oriented on the fluid supply pipes in the same manner. As a result, prior cages have been made more cost effective by enlarging the cage (or cover) and/or the opening thereto which receives the sprinkler head, such that a given cage configuration or size can accommodate multiple different sizes or configurations of sprinkler head. However, doing so can increase the misalignment of the sprinkler head within the cage and possibly adversely affect the performance of the sprinkler head.

As a result, removable yokes have been added to prior cages which can be sized and/or shaped to accept specific types or sizes of sprinkler head and ensure a specific orientation of the sprinkler head within the cage. These yokes can, for example, be slidably mounted to closely engage opposing sides of the sprinkler head, and then fixedly mounted, adjacent to the cage opening into which the sprinkler heads are received, by means of conventional fasteners (such as nuts and bolts) through holes at specific predetermined locations on the cage. However, doing so can require significant manual effort in orienting the individual elements and then aligning the fasteners and holes appropriately. Further, each type and/or size of sprinkler head can require its own specially formed yoke. Also, either multiple extra holes would be need to be preformed in the cage to receive fasteners for different yokes or on-site hole drilling would be needed for each yoke type/size.

Further, some cages may be attached to the fluid supply pipes by inexpensive brackets or straps which will permit angular or rotational motion of the cage about the pipe in respect to sufficient impact force. That motion can, in some circumstances, lead to collision of the cage with a portion of the sprinkler head assembly which is sufficient to either block sprinkler head actuation during a fire, or cause sprinkler head actuation from the collision. It has been suggested that such collision motion can be minimized by the use of such yokes, especially where the yokes are formed to specifically locate the sprinkler head. However, prior yoke arrangements can still have the disadvantages noted above when used in that manner.

### SUMMARY

The sprinkler head cage(s) disclosed herein provide improved sprinkler systems for fire protection systems. These improvements include providing sprinkler systems which:
a. have a less overall cost of manufacture, installation, and maintenance,
b. increase the economy and/or versatility of protective cages/covers for sprinkler heads,
c. comply with fire protection regulations despite protection against inadvertent actuation,
d. are aesthetically attractive to users,
e. accommodate a wide variety of sprinkler head types and sizes, and
f. increase safety and convenience for building occupants.

These and other objectives may be achieved by the provision of a sprinkler head cage (which prevents inadvertent actuation of a sprinkler head without significant reduction in sprinkler head fire suppression capability), having an enlarged opening for receiving a variety of different sprinkler head sizes and/or configurations, with a slidably mounted yoke for engaging a sprinkler head, having a camming surface therein for directing alignment of the sprinkler head within the cage as the camming surface is moved along a portion of the sprinkler head. The yoke can provide a positive fit and/or location for the sprinkler head within the cage where the camming surface directs the yoke into engagement with opposing surfaces of the sprinkler head sufficient to restrict motion of the sprinkler head with respect to the cage.

Other objects, advantages, and novel features will become readily apparent from the following drawings and detailed description of certain preferred and alternative embodiments.

The present disclosure includes the aesthetic appearance of the sprinkler head cage with an integrated, generally “V” shaped, slidable camming yoke closely associated with the cage opening for the sprinkler head. This sprinkler head cage arrangement can be assembled and sold with a new fire protection system installation or as a separate module for retro-fit into previously and/or separately build and sold fire protection systems. The present inventive design differs from the prior art by the shape of the yoke (which is not a strict “V”, as shown in FIG. 7 herein) and in the slide mounting which abuts the underside of the cage opening. The present design does not include welding artifacts, discoloration, or the weld points themselves.

### BRIEF DESCRIPTION OF THE DRAWINGS

FIG. 1 shows a front view of a portion of a fire protection system incorporating a preferred embodiment;

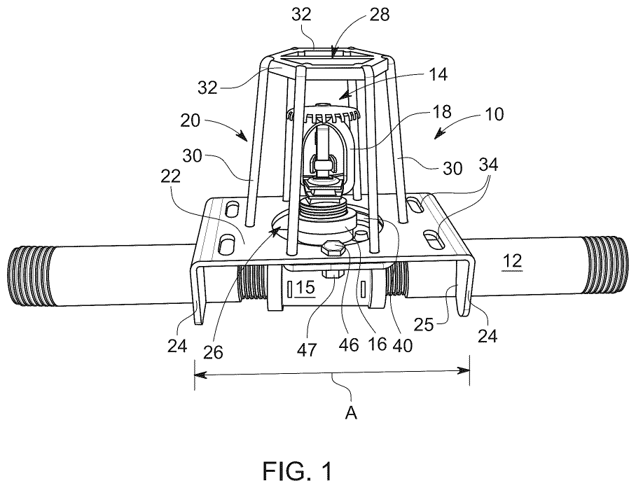

FIG. 2 shows a top view of the embodiment of FIG. 1;

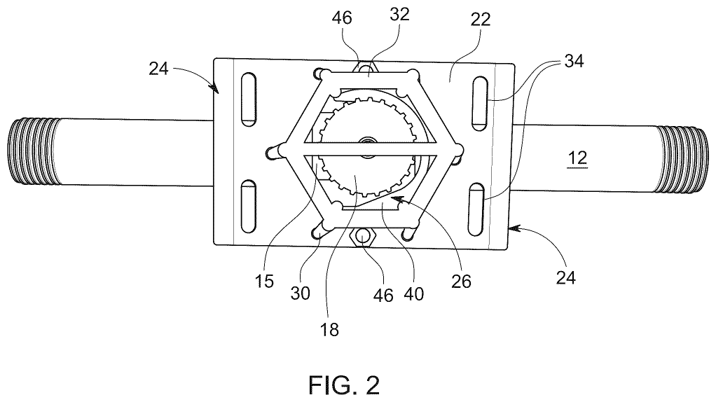

FIG. 3 shows a front, right, upper perspective schematic view of a sprinkler head assembly cover or cage incorporating an embodiment;

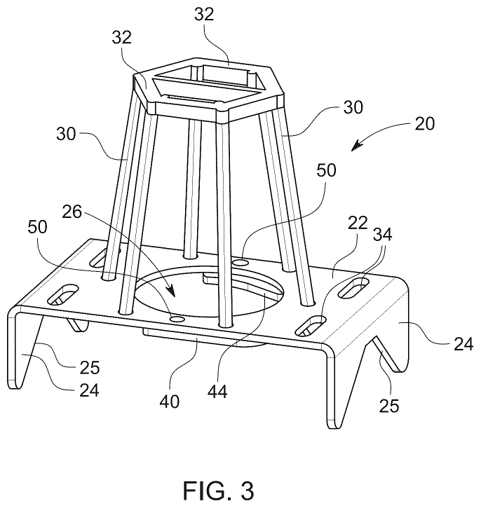

FIG. 4 shows a front schematic view of the embodiment of FIG. 3;

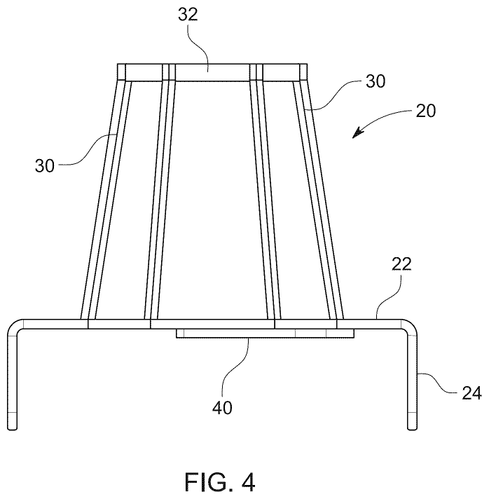

FIG. 5 shows a side schematic view of the embodiment of FIG. 3;

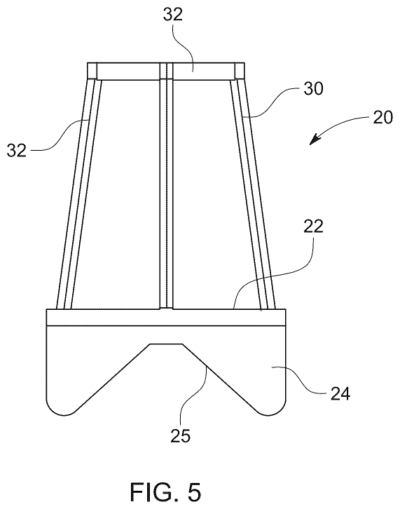

FIG. 6 shows a bottom schematic view of the embodiment of FIG. 3;

FIG. 7 shows a top plan view of a prior art yoke element;

FIG. 8 shows a back, upper perspective view of a protective cover design;

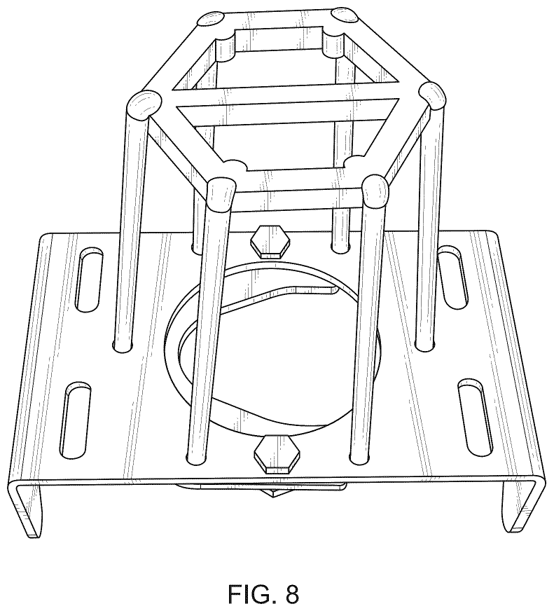

FIG. 9 shows a front, left, upper perspective view of the cover of FIG. 8;

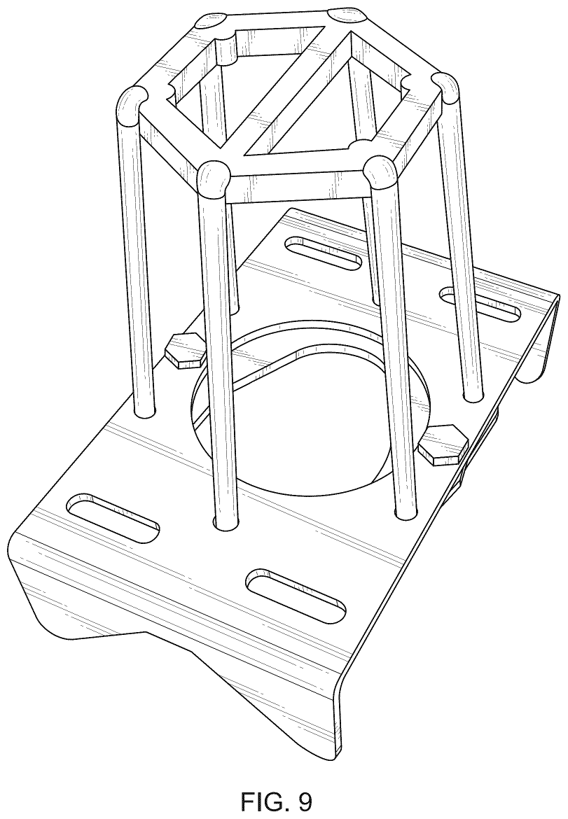

FIG. 10 shows a left, upper perspective view of the cover of FIG. 8; and

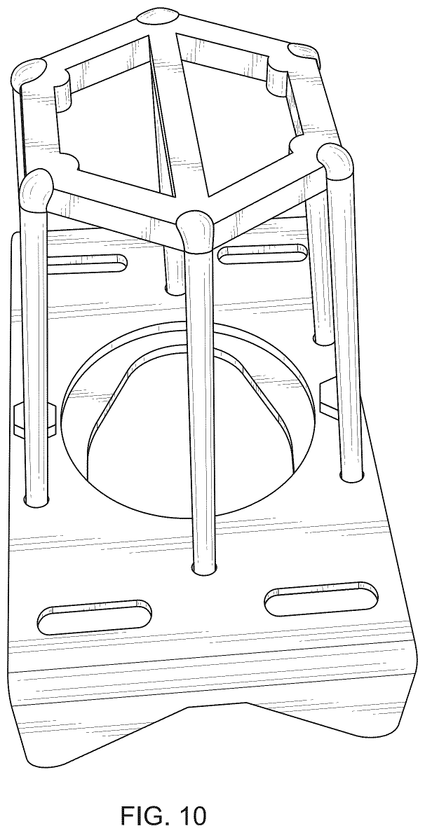

FIG. 11 shows front, lower perspective view of the cover of FIG. 8.

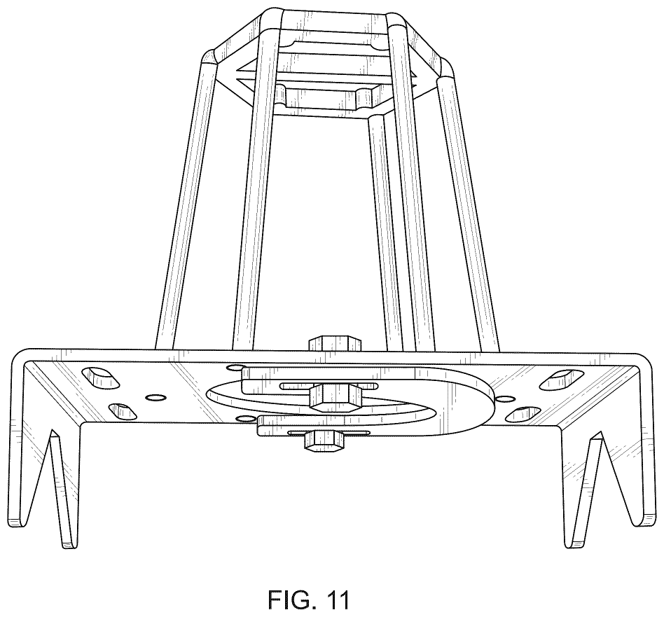

### DESCRIPTION OF THE PREFERRED EMBODIMENTS

The figures show schematically, and in best mode versions, embodiments of the present disclosure, particularly as applied to a fire protection system, both generically and specifically as applied to the interior of static structures, such as warehouses and/or factories. The drawings are not precisely to scale from one to the next.

The following numbered features are illustrated in the drawings:
a fire protection system 10, having
a fluid supply pipe 12 (a fluid carrying conduit for providing water or other fire retardant fluid),
sprinkler head assembly 14, having
   a fitting 15 (connected to pipe 12), having
      an enlarged boss 16, adjacent the reception opening for
   a sprinkler head actuation device 18,
a cover 20, having
   a longitudinally extending base member 22 (the “longitudinal” orientation being along (or parallel to) line “A”, the length direction of pipe 12 to which fitting 15 is connected when adjacent to sprinkler head assembly 14),
   at least one flange 24, extending generally orthogonally (meaning at least generally perpendicular to the longitudinal direction of base member 22), and having a slot or notch 25 for receiving therein at least a portion of pipe 15,
   an opening 26,
   a cage member 28 disposed on one side of that opening (preferably mounted on base member 22 via welding, for example), having
      a plurality of vertical bars 30, connected by
      one or more cross bars 32 at the top of the cage member and/or intermediate the length of vertical bars 30, as needed for reinforcement in given applications of the present disclosure,
   pipe mounting slots 34, for receiving conventional fasteners (such as U-bolts) to removably secure cover 20 to pipe 15 at a desired location,
   openings 50, for removably receiving fasteners 46 (described below), and
an element 40 which serves as a yoke with respect to boss 16, having
   a tapered recess 42, preferably in the general form of a V or inwardly tapered U (as opposed to a conventional, straight sided U), having
   elongated slots 48 for removably receiving fasteners 46 passing through opening 50 and slots 48 (fasteners 46 preferably being conventional threaded bolts removably secured in place by nuts 47), such that element 40 is movably mounted via close or adjacent sliding engagement with the cover 20, and
   at least one camming surface 44.

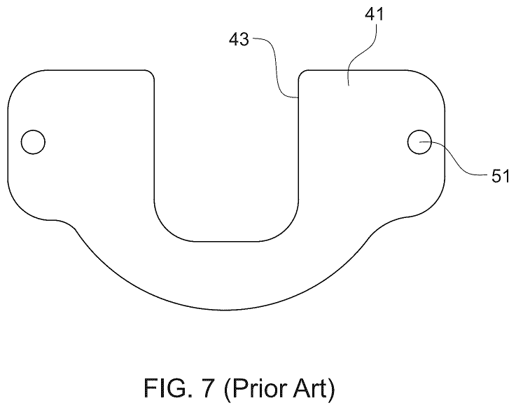

In addition, FIG. 7 shows a prior art yoke element 41 having a non-tapered recess 43 for receiving therein boss 16 without the use of a camming surface, since it employs a conventional, straight sided U as recess 43.

Briefly, these elements interact as follows:

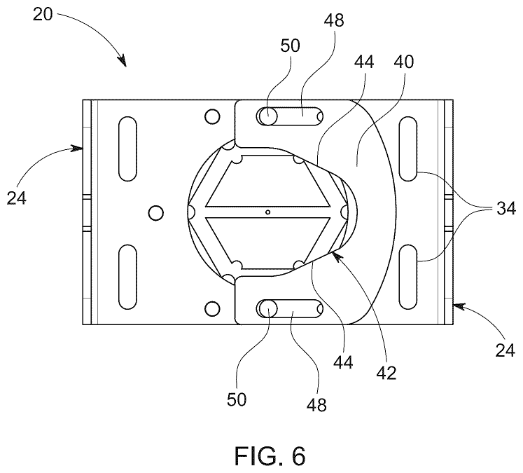

Fastener 46 serves as a locating pin for yoke element 40, which is, for example, initially placed adjacent to opening 26, and preferably (but not necessarily) on the opposite side of base member 22 from cage 28, and slid to the right, with respect to the view of FIG. 6, to the full extent permitted by slots 48, so as to provide the least obstruction of opening 26 as sprinkler head assembly 14 is inserted into opening 26. Thereafter, for example, sprinkler head assembly 14 is positioned at its desired location within cover 20, and yoke element 40 is slid toward the left (with respect to the view of FIG. 6) to secure the sprinkler head assembly against movement out of that position. Yoke element 40 accomplishes this by engagement of camming surface 44 with portions of fitting 15 underneath boss 16 (that boss typically forming a radial extension of the fitting outward from the main portion of the fitting). Camming surface 44 serves as a guide for the yoke to preferably bring it into engagement with fitting 15 on opposing sides of tapered recess 42 and thereby positively lock the yoke element against fitting 15 directly underneath boss 16. One the yoke element is in place to sufficiently provide the positive lock, nut 47 is threaded tight onto fastener bolt 46. Yoke element 40 is formed and fastened such that it can be easily removed from engagement with fitting 15, without undue binding even if some incidental corrosion or other substance buildup between those members would otherwise create adhesion, such as may be needed if, for example, that removal is necessary for servicing of the sprinkler head assembly.

In this way:
movement of the yoke element with respect to the sprinkler head assembly along that camming surface can cause alignment of the sprinkler head assembly with the cover,
the yoke element is formed to receive portions of differently sized or configured sprinkler head assemblies and restrict movement of the sprinkler head assembly with respect to the cover,
the yoke element is formed such that the restriction of movement occurs after the alignment of the sprinkler head assembly with the cover or can be used to create that alignment,
the yoke element is disposed with respect to the cover such that the camming surface engages the fitting during the movement of the yoke element which can cause alignment of the sprinkler head assembly with the cover,
the movement of the yoke element along that camming surface can cause rotational alignment of the sprinkler head assembly with the cover,
movement of the yoke element with respect to the sprinkler head assembly along that camming surface causes alignment of the sprinkler head assembly with the cover, and
the yoke element is formed to receive portions of the sprinkler head assembly and restrict movement of the sprinkler head assembly with respect to the yoke after the alignment of the sprinkler head assembly with the yoke.

Although the presently disclosed concepts have been shown and described herein with respect to certain preferred embodiments and alternative configurations, those were by way of illustration and example only. For example, in other embodiments a threaded projection on base member 22 can penetrate slots 48 and replace opening 50 and threaded fastener 46. Also, separate, spaced-apart legs can replace flanges 24 at one or both longitudinal ends of base member 22, and those legs can extend at an angle with respect to the base member, rather than orthogonally, to engage pipe 15. Further, opening 26 is shown to be circular, but it can, as needed, be rectangular or of another shape sufficient to accommodate insertion of a portion of the sprinkler head assembly. Still further, slots 34 need not be used in some instances, such as where the cover is to be permanently fixed to the pipe or with respect to the sprinkler head assembly. In addition, base member 22 need not be mounted in parallel to line A in all instances, provided that the cover is sufficiently mounted to protect the sprinkler head actuation device.

Accordingly, the spirit and scope of the present invention is intended to be limited only by the terms of the appended claims as interpreted according to the principles of patent law including the doctrine of equivalents.

1. An arrangement for preventing inadvertent activation of the sprinkler head assembly of a fire protection system, comprising:
a cover formed to at least partially enclose the sprinkler head assembly, having an opening into which at least a portion of the sprinkler head assembly is disposed,
a element movably mounted with respect to the opening, having a camming surface for engagement with a portion of the sprinkler head assembly,
wherein movement of the element with respect to the sprinkler head assembly along that camming surface causes alignment of the sprinkler head assembly with the cover.

2. The arrangement of claim 1 wherein the element is formed to receive portions of the sprinkler head assembly and restrict movement of the sprinkler head assembly with respect to the cover.

3. The arrangement of claim 2 wherein the element is formed such that the restriction of movement occurs after the alignment of the sprinkler head assembly with the cover.

4. The arrangement of claim 2 wherein:
the fire protection system includes a fluid supply pipe,
the sprinkler head assembly includes a fitting connecting the sprinkler head to the fluid supply pipe and a sprinkler head actuation device for mounting into that fitting, and
the element is disposed with respect to the cover such that the camming surface engages the fitting during the movement of the element which causes alignment of the sprinkler head assembly with the cover.

5. The arrangement of claim 2 including:
a fire protection system which includes a fluid supply pipe,
the sprinkler head assembly includes a fitting connecting the sprinkler head to the fluid supply pipe and a sprinkler head actuation device for mounting into that fitting, and
the element is disposed with respect to the cover such that the camming surface engages the fitting during the movement of the element which causes alignment of the sprinkler head assembly with the cover.

6. The arrangement of claim 1 wherein the element is movably mounted via sliding engagement with the cover.

7. The arrangement of claim 6 wherein either the cover or the element includes at least one projection therefrom and the other of which includes a slot for receiving that projection, such that the sliding engagement occurs by relative movement of the projection within the slot.

8. The arrangement of claim 7 wherein the projection is formed as a threaded fastener for clamping the element to the cover.

9. The arrangement of claim 1 wherein the movement of the element along that camming surface causes rotational alignment of the sprinkler head assembly with the cover.

10. An arrangement for preventing inadvertent activation of the sprinkler head assembly of a fire protection system having a fluid conduit and at least one sprinkler head assembly connected to the fluid conduit, for receiving and distributing fire retardant fluid therefrom, comprising:
a cover formed to at least partially enclose the sprinkler head assembly, having
a longitudinally extending base member, having
a flange extending generally orthogonally at each longitudinal end of the base member,
each flange having a recess therein for receiving a portion of the fluid conduit therein,
an opening dimensioned so as to permit at least a portion of the sprinkler head assembly to pass therethrough,
a cage member disposed on one side of that opening so as to surround the portion of the sprinkler head assembly which passes through the opening,
a yoke, slidably mounted to the base member adjacent to the opening, formed to selectively prevent removal of the sprinkler head assembly from the cover, having
a camming surface for engagement with a portion of the sprinkler head assembly,
wherein movement of the yoke with respect to the sprinkler head assembly along that camming surface causes alignment of the sprinkler head assembly with the cover, and
wherein the yoke is formed to receive portions of the sprinkler head assembly and restrict movement of the sprinkler head assembly with respect to the yoke after the alignment of the sprinkler head assembly with the yoke.

11. The arrangement according to claim 9 wherein the yoke is formed with a tapered recess for receiving and restricting movement of multiple different size sprinkler head assemblies.
